(19) United States
(12) Patent Application Publication
(10) Pub. No.: US 2026/0370987 A1
(43) Pub. Date: Nov. 19, 2026

(54) DIGITAL DEVICE CAPABLE OF READING PRESSURE POINTER ON CONVENTIONAL PRESSURE GAUGE

(71) Applicant: LINGJACK ENGINEERING WORKS PTE LTD, Singapore (SG)

(72) Inventor: Kok Kheng LIM, Singapore (SG)

(21) Appl. No.: 19/652,077

(22) Filed: Apr. 20, 2026

(30) Foreign Application Priority Data
May 15, 2025 (SG) 10202501249Q

(51) Int. Cl. H04Q 9/00; G08B 21/18

(52) U.S. Cl. CPC H04Q 9/00; G08B 21/182

(57) ABSTRACT

A SMART measuring sensor system for non-intrusively monitoring conventional pressure dial gauges is disclosed. The system comprises electronic sensors positioned to detect the position of a gauge's pointer/indicator, a microprocessor to interpret the pointer position data into corresponding pressure readings, and communication means to transmit the readings to monitoring systems. The system enables continuous or intermittent monitoring of pressure without requiring any modification to existing gauges, while preserving the ability to manually read the gauges when desired. This solution eliminates the need for personnel to be stationed on-site for manual readings, provides real-time monitoring capabilities, enables data logging for trend analysis, and can generate alerts when abnormal pressure conditions occur.

### BACKGROUND OF THE INVENTION

### A. Field of The Invention

The present invention relates to a digital device capable of reading pointer on pressure gauge, and in particular, utilizing a SMART measuring sensor to accurately read conventional measuring instruments without the need for any modifications to the original equipment, which offers a more convenient and efficient method for recording current measurements.

### B. Description of Prior Art

Pressure monitoring is essential in numerous industrial, commercial, and scientific applications. Conventional pressure dial gauges are widely deployed across facilities worldwide due to their reliability, simplicity, and cost-effectiveness. These gauges typically feature a mechanical pointer that indicates pressure readings on a calibrated dial face. Traditional monitoring of such gauges requires manual reading by personnel stationed on-site, which presents several limitations: labor costs, human error potential, intermittent data collection, and inability to provide real-time monitoring or automated alerts when abnormal pressure conditions occur.

Various solutions have been proposed to address these limitations, including replacement of conventional gauges with digital alternatives having built-in electronic outputs. However, these solutions often require significant infrastructure changes, system downtime, recertification, and substantial capital investment. There exists a need for a technology that can provide continuous monitoring of existing analog pressure gauges without requiring their modification or replacement, while offering the benefits of digital monitoring systems including remote access, automated data logging, and integration with modern monitoring and control systems.

Several million air, water, and oil pressure dial gauges have been distributed globally for collecting data for various purposes. The pressure dial gauge is a commonly employed tool for evaluating the pressure within a system or product. Analog pressure dial gauges typically lack output capabilities, requiring in-person presence to manually record readings.

Individuals are required to physically visit the location to access the essential information on the system's condition. For real-time monitoring needs, digital measuring devices, whether wired or wireless, must be integrated or substituted for the pressure dial gauge. This process results in additional expenses and potential downtime to retrofit or incorporate remote monitoring capabilities.

The Pressure Dial gauge has been utilized for several years and continues to be utilized due to its cost-effectiveness and simplicity in providing pressure readings. However, obtaining readings requires physical presence on-site, making continuous monitoring impossible without additional measuring devices that offer output in analog or digital format. The costs, installation time, and ongoing calibration efforts associated with these additional devices pose challenges. Additionally, the constant need for physical presence to take readings presents difficulties in the current labor shortage climate.

US Patent No. 4300548, entitled “System for detecting position of gauge pointer", discloses a system including a stationary light source which is positioned adjacent the pointer. A lens receives the light from the light source and redirects the light in at least one elongated light beam directed toward the pointer. In the preferred embodiment, the light source is located along the pointer's axis of rotation and the lens bends the light rays 90° to form at least one arcuate light beam. A plurality of elongated light beams can be used and variations of different shapes of light beams can readily be used by so designing the lens means. A light sensitive detector is positionable in the gauge itself and is movable along a guided path on the opposite side of the pointer than is the light source. The guided path generally follows the particular shape of light beams that is directed toward the needle. The function of the light detector is to sense, and provide some signal when the pointer passes across the sensor, thereby substantially reducing the amount of light directed toward the sensor. In this manner the detector signals the position of the pointer. The sensor may be moved within limits to an infinite number of positions along the elongated light beam by conveniently located knobs outside the gauge. The operator thus can, by simply turning a knob, adjust a sensor to a desired position and the sensor will detect when the gauge pointer passes or remains at that position.

US Patent Publication NO. 12044549B2 discloses an optical reading device of a pointer instrument having a pointer and a scale face or dial with different reflection properties, comprising:
an illumination apparatus for illuminating the scale face or dial of the pointer instrument; and
a plurality of triangular light sensor elements which are arranged in a circle about a rotation axis of the pointer for capturing light of the illumination apparatus reflected back by the scale face or dial of the pointer instrument;
wherein the illumination apparatus is configured to evenly illuminate the scale face or dial at least in a region opposite the circle; and
wherein the plurality of triangular light sensor elements each substantially formed as isosceles triangles and are each arranged adjacent to one another along a circumferential direction of the circle.

Two additional optical reading devices for a similar pointer instrument are disclosed in U.S. Patents 6,157,311 A and 4,275,393 A. These devices function by illuminating the pointer instrument and detecting the pointer position or any movement exceeding the pointer position using a light sensor. Similarly, U.S. Patent 8,325,050 B1 and U.S. Patent 7,377,184 B1 describe reading devices that detect the movement of a triangular marking on the pointer base or the movement of a star-shaped inlet rotor in a water meter.

Accordingly, the present disclosure proposes a non-intrusive SMART measuring device capable of remotely reading the pressure dial gauge statuses without requiring any alterations to the current system. This proposed invention will eliminate the necessity of on-site visits and costly system modifications, leading to a reduction in downtime, effort, and expenses.

### BRIEF SUMMARY OF THE INVENTION

A main object of the present invention is to provide a digital device capable of remotely monitoring pressure statuses on existing pressure dial gauges without the need for any system modifications. This invention eliminates the requirement for costly site visits and extensive system alterations, thus reducing downtime, effort, and expenses. The digital device can be easily attached to an existing pressure dial gauge without disrupting its current functions. The device will continuously monitor pressure statuses and promptly alert users if any abnormalities are detected.

A further main object of the present invention is to provide a digital device capable of remotely monitoring pressure statuses on exciting pressure dial gauges, wherein data collected by the digital monitor device will be transmitted to a backend server for display, data processing, and recording purposes. Any maintenance personnel will have secure remote access to the backend server for real-time readings, status/fault monitoring, historical data, and report generation.

A further object of the present invention is to provide a digital device capable of remotely monitoring pressure statuses on existing pressure dial gauges, which offers a cutting-edge solution and a streamlined approach to monitoring pressure levels, effectively enhancing operational efficiency and minimizing maintenance costs.

The present invention provides a SMART measuring sensor system designed to non-intrusively read and record measurements from conventional pressure dial gauges without requiring any modification to the existing gauges. In one aspect, the invention comprises an electronic sensor array positioned to detect the position of a gauge's pointer/indicator, a microprocessor to interpret the pointer position data into corresponding pressure readings, and communication means to transmit the readings to monitoring systems. The invention provides continuous 24/7 monitoring capability without requiring human presence, while preserving the ability to manually read the gauge when desired. This system addresses the limitations of conventional dial gauge monitoring by enabling automated data collection, remote monitoring, trend analysis, and integration with digital monitoring systems, all while leveraging existing gauge infrastructure.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE SEVERAL VIEWS OF THE DRAWING

The invention will now be described using exemplary embodiments and making reference to the drawings, in which:

FIG. 1 illustrates a schematic representation of the SMART measuring sensor system installed on a conventional pressure dial gauge, wherein the reading on a pressure dial gauge is able to be read from the sensor system, in accordance with the present invention.

FIG. 2 shows a block diagram of the system components including sensors, microprocessor, and communication modules in accordance with the present invention.

FIG. 3 depicts the sensor array configuration for detecting pointer positions in accordance with the present invention.

FIG. 4 illustrates the data flow from physical pointer position to interpreted pressure reading in accordance with the present invention.

FIG. 5 shows various mounting configurations for different gauge types in accordance with the present invention.

FIG. 6 is an exemplary embodiment of a digital device mounted on a pressure gauge in accordance with the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

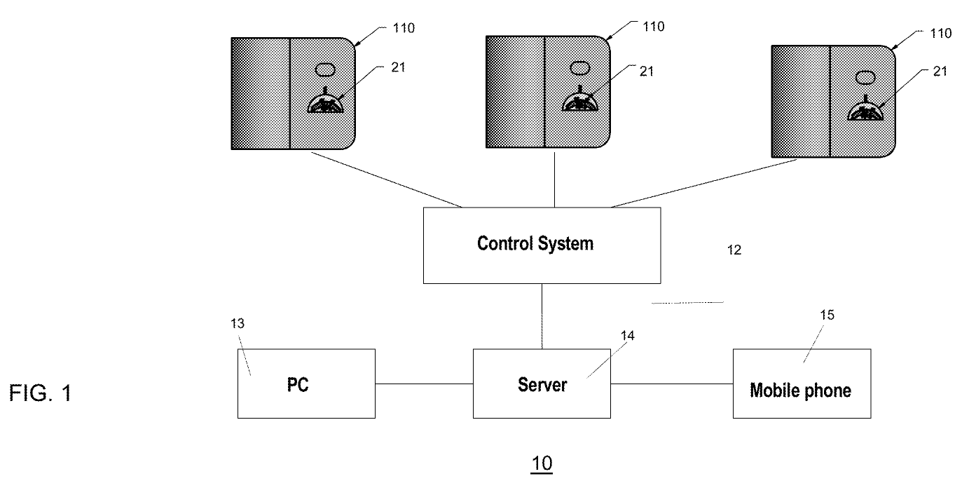

Referring to FIG. 1, broadly, there is shown a schematic representation of the SMART measuring sensor system (10) to be installed on a conventional pressure dial gauge via an electronic mount (110). The SMART measuring sensor system (10) of the present invention provides a non-intrusive solution for digitizing readings from conventional pressure dial gauges without requiring any modifications to the gauges themselves. The system (10) employs electronic sensors to detect the position of a gauge's pointer, processes this positional data to determine corresponding pressure readings, and transmits these readings to monitoring systems for recording, analysis, and alerting purposes. The measuring sensor system (10) is linked to a control system (12), wherein the control system (12) is connected to a server (14). A PC (13) and/or a mobile phone (15) can access to the server (14). The position of the printer is also visualized via an aperture (21) made on the electronic mount (110). A plurality of the electronic mounts (110) can be mounted onto a plurality of pressure gauges and are linked to a common control system (12).

### System Components

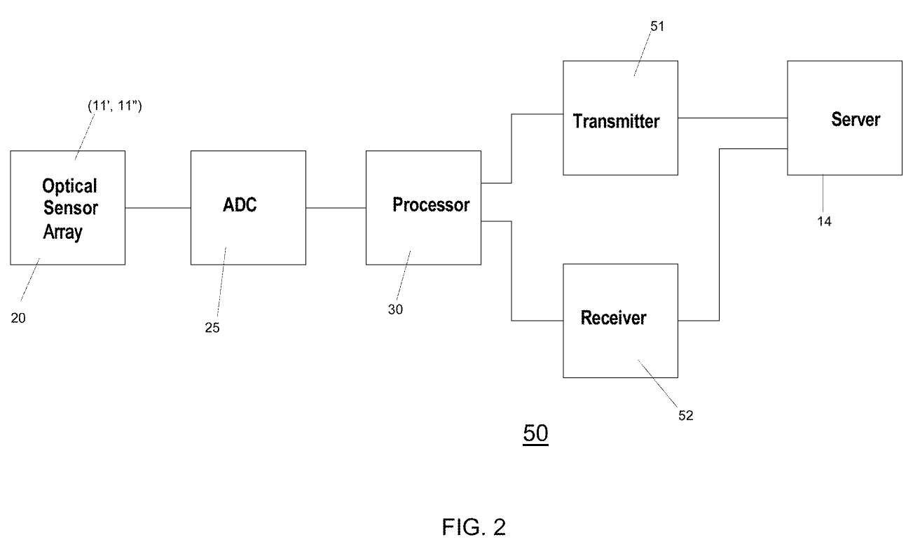

Referring to FIG. 2, the SMART measuring sensor system (10) comprises:
a) a plurality of optical sensor (11, 11’, 11”) as a sensor array (20) positioned onto the electronic mount (not shown), and then mounted onto the pressure dial gauge (not shown);
b) a ADC (25);
c) a microprocessor unit (30) for data processing;
d) a power supply (40);
e) a communication module (50) including a transmitter (51) and a receiver (52) for data transmission; and
f) an optional local display linked to a server (14).

FIG. 2 shows a block diagram of the system components including sensors, microprocessor, and communication modules in accordance with the present invention.

The optical sensor array (20) is the starting point of the system. The position of the pointer is captured through optical means (light). The signal from the optical sensor array (20), which is probably analog, is converted into a digital signal by the ADC (25), making it suitable for processing by a computer. The core of the system is the processor (30) and processes the digital signal received from the ADC (25). It likely performs calculations and other data manipulations based on the input. The transmitter (51) and receiver (52) are responsible for communication. The receiver (52) receives signals, while the transmitter (51) sends them. The final component in the system is the server (60) which contains all the information related to the processing of the system.

Overall System Function as follows:
1. The Optical Sensor captures data.
2. The data is converted to a digital signal by the ADC.
3. The Processor processes the digital signal.
4. The processed data is transmitted to the Server via the Transmitter and Receiver.

### Sensor Technology

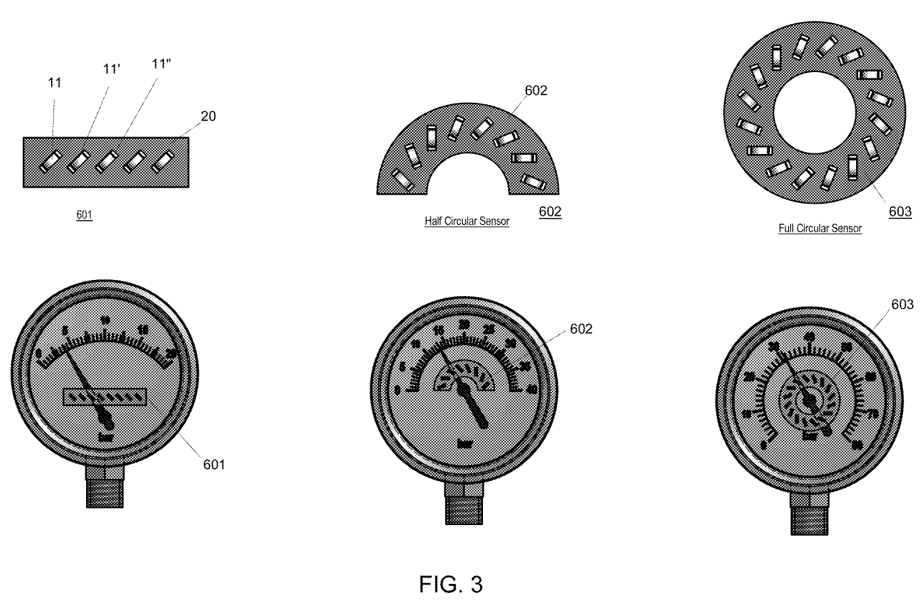

The system (10) employs one or more electronic sensors (11, 11’, 11”) arranged in a specific configuration to detect the position of the gauge pointer. In the preferred embodiment, infrared (IR) sensors are utilized due to their accuracy, reliability, and minimal power requirements. As illustrated in FIG. 3, a row of IR sensors (11, 11’, 11’’, ...) can be in the form of a linear sensor (601), or half circular sensor (602) or a full circular sensor (603), and is positioned to cover the arc of possible pointer positions. Each sensor is capable of detecting whether the pointer is within its detection zone. By determining which sensor(s) detect the pointer, the system (10) can determine the angular position of the pointer.

In accordance with the present invention, alternative sensor technologies may include, but are not limited to:
a) Optical sensors;
b) Image sensors with computer vision processing;
c) Magnetic sensors if the pointer contains ferromagnetic material;
d) Capacitive sensors; or
e) A combination of multiple sensor types for increased accuracy and redundancy.

As shown in FIG. 1, the system (10) further comprises an electronic mount (110) which is capable of mount onto a conventional pointer gauge together with the system (10) where the reading of the pointer can be read from the system (10) via the aperture (21) on the electronic mount (110).

### Processing Methodology

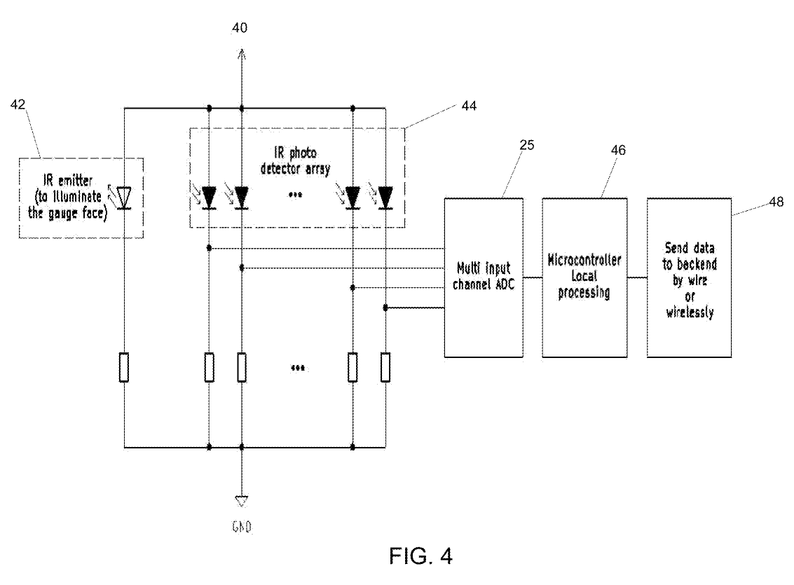

FIG. 4 illustrates the data flow from physical pointer position to interpreted pressure reading in accordance with the present invention. As shown, an infrared emitter array (42) is shown and it is suggested that the system uses infrared light to read data from a gauge. A plurality of emitters are used in the preferred embodiment of the present invention. Below the emitters is an infrared photo detector array (44). This array (44) receives the reflected infrared light from the gauge face. The light intensity variations are then interpreted as data. Both the IR emitter and IR photo detector array (44) are connected to a power source (VCC).

The signal from the IR photo detector array (44) is fed into a multi-input channel Analog-to-Digital Converter (ADC) (25). This converts the analog light signals into digital data that the microcontroller (46) can understand. The microcontroller (46) processes the digital data received from the ADC (25). This likely involves signal conditioning, filtering, and potentially some initial data interpretation.

The processed data is then sent to a backend system (48), either via a wired connection or wirelessly. This suggests further analysis and storage of the data.

FIG. 4 indicates the system used to optically read data from a gauge using infrared light. The data is then processed locally and sent to a backend system for further analysis or display. The use of multiple emitters and detectors suggests a more robust and potentially higher-resolution reading system.

The microprocessor unit (46) employs sophisticated algorithms to interpret the sensor data and convert pointer position information into accurate pressure readings. This process involves several key steps. Initial Calibration: During system installation, the sensor array is calibrated by recording sensor readings at known pressure points. This creates reference points correlating sensor readings to actual pressure values. Interpolation: For pointer positions between calibration points, mathematical interpolation algorithms are employed to determine precise pressure values. Dynamic Adjustment: The system continuously refines its calibration based on observed pointer movements, enhancing accuracy over time. The microprocessor implements these algorithms to provide real-time pressure readings that closely match what would be observed by human operators reading the gauge directly.

### Data Communication

The communication module (50) enables transmission of processed readings to monitoring systems. The system supports multiple communication methods including:
a) Wired options: Ethernet, or direct USB connection;
b) Wireless options: Wi-Fi, Bluetooth, LoRaWAN, Zigbee, cellular networks (2G/3G/4G/5G), or proprietary RF protocols. The communication protocol incorporates encryption and authentication measures to ensure data security and integrity.

### Power Management

The power supply (40) may be implemented through various means:
a) Direct connection to facility power;
b) Battery power with long-term operation capability;
c) Solar power with battery backup; or
d) Energy harvesting from ambient vibrations or temperature differentials.

The system incorporates power management features to minimize energy consumption, particularly important for battery-powered installations.

### Physical Mounting

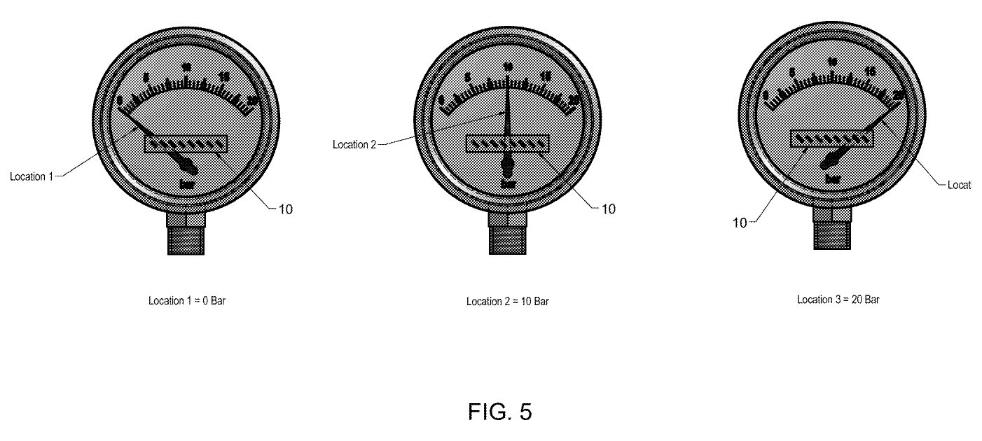

As illustrated in FIG. 5, the SMART measuring sensor system is designed for versatile mounting on various types and sizes of pressure dial gauges. The mounting mechanism:
a) Secures the sensor array at the optimal distance from the gauge face;
b) Allows for precise alignment with the pointer's rotation center;
c) Does not obstruct visual reading of the gauge; and
d) Minimizes interference with regular gauge operation and maintenance.

The mounting system may employ magnetic attachment, clamps, brackets, or adhesives depending on the specific installation requirements and gauge characteristics.

### Implementation Variations

The invention encompasses several implementation variations:
Multi-Gauge Monitoring: A single processing unit may be configured to monitor multiple gauges simultaneously, with separate sensor arrays for each gauge.
Integrated Analysis: The system may incorporate advanced analytics capabilities for detecting trends, identifying anomalies, and predicting potential issues based on pressure patterns.
Expanded Measurement Types: While primarily designed for pressure gauges, the same principle and technology can be applied to other dial-type instruments such as temperature gauges, flow meters, level indicators, and various analog measuring instruments.

### Operation Process

The operation of the SMART measuring sensor system follows these steps:
Installation and Initial Setup: The sensor array is mounted in front of the pressure dial gauge without modifying the gauge itself. The system is powered on and an initial calibration procedure is performed.
Continuous Monitoring: The sensors continuously detect the position of the gauge pointer. This can be configured for constant monitoring (24/7) or intermittent readings at programmable intervals to conserve power.
Data Processing: The microprocessor receives signals from the sensors, processes the data using calibrated algorithms to determine the corresponding pressure reading.
Data Transmission: Processed readings are transmitted via the selected communication method to monitoring systems, control rooms, databases, or cloud platforms.
Alerting and Reporting: The system can be configured to generate alerts when pressure readings fall outside predetermined thresholds, and to produce periodic reports of pressure trends.

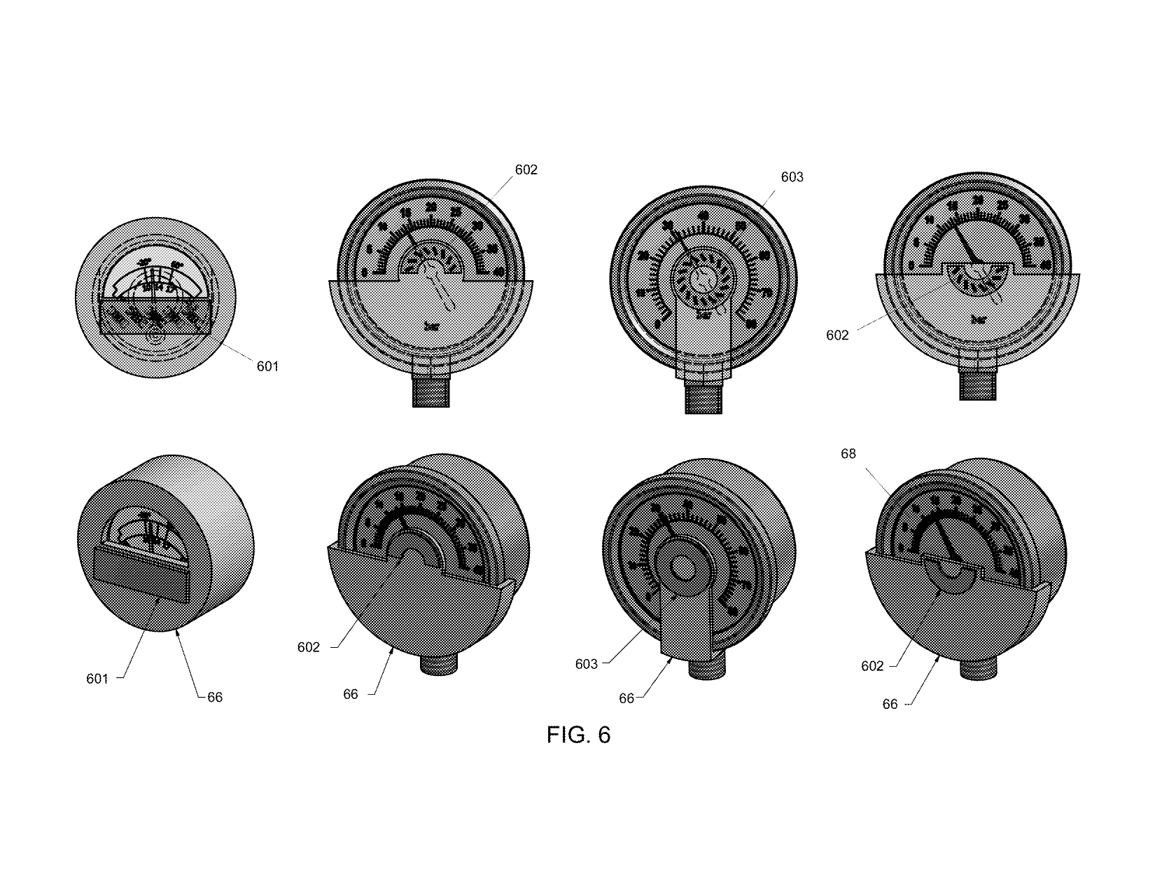

FIG. 6 shows, by way of example, an exemplary embodiment of a digital device (10) or SMART measuring sensor system (10) in the form of a flat linear sensor (601) or half circular sensor (602), full circular sensor (603), that is cemented onto a mounting 66 which is then directly fitted onto the transparent glass cover (68) of a conventional pressure gauge. The digital device or the sensor can also be differently mounted, for example, cemented onto the transparent glass cover (68) where the pointer and the reading of the pressure gauge are corresponding to the sensor . The pointer is a commonplace circular instrument with a pointer that rotates about an axis of the pressure gauge.

The sensor system (10) is arranged and configured such that, firstly, it lies opposite the pointer 4 so that it captures the deflection range of the pointer fully and, secondly, further enables a view of the scale labelling and, at least partially, the pointer. In particular, the sensor system (10) can be configured transparent in large parts.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. This invention is defined by the following claims, with equivalents of the claims to be included therein.

1. A system for non-intrusively monitoring conventional pressure dial gauges, comprising:
a) at least one electronic sensor positioned to detect the position of a gauge pointer corresponding to pressure readings;
b) a processing unit configured to interpret sensor data and convert pointer position into pressure values;
c) a communication module for transmitting processed readings; and
d) a mounting mechanism for attaching the system to a conventional pressure dial gauge without requiring modification of said gauge.

2. The system of claim 1, wherein the at least one electronic sensor comprises an array of infrared sensors arranged to detect different possible positions of the gauge pointer.

3. The system of claim 1, wherein the processing unit employs interpolation algorithms to determine pressure readings based on pointer positions between calibrated reference points.

4. The system of claim 1, wherein the communication module employs at least one of wired or wireless communication protocols to transmit readings to external monitoring systems.

5. The system of claim 1, further comprising a power management system to enable extended operation in remote locations.

6. The system of claim 1, wherein the mounting mechanism preserves visibility of the gauge face for manual reading.

7. A method for non-intrusively monitoring a conventional pressure dial gauge, comprising:
a) detecting the position of a gauge pointer using at least one electronic sensor positioned in proximity to the gauge;
b) processing the detected position data to determine corresponding pressure readings;
c) transmitting the determined pressure readings to at least one monitoring system; and
d) recording the pressure readings for monitoring and analysis purposes.

8. The method of claim 7, further comprising calibrating the system by correlating specific sensor readings with known pressure values.

9. The method of claim 7, further comprising generating alerts when detected pressure readings fall outside predetermined thresholds.

10. The method of claim 7, further comprising analyzing recorded pressure readings to identify trends and predict potential issues.
